(19) United States
(12) Patent Application Publication
(10) Pub. No.: US 2015/0372397 A1
(43) Pub. Date: Dec. 24, 2015

(54) AN ANTENNA ARRANGEMENT AND A BASE STATION

(71) Applicant: CELLMAX TECHNOLOGIES AB, Kista (SE)

(72) Inventors: Stefan JONSSON, Sollentuna (SE); Dan KARLSSON, Sollentuna (SE)

(73) Assignee: CELLMAX TECHNOLOGIES AB, Kista (SE)

(21) Appl. No.: 14/764,974

(22) PCT Filed: Jan. 16, 2014
(86) PCT No.: PCT/SE2014/050047

§ 371 Date: Jul. 30, 2015

(30) Foreign Application Priority Data
Jan. 31, 2013 (SE) 1350119-2

(51) Int. Cl. H01Q 21/30; H01Q 21/08; H01Q 21/00; H01Q 19/10

(52) U.S. Cl. CPC H01Q 21/30; H01Q 19/10; H01Q 21/08; H01Q 21/0006

(57) ABSTRACT

An antenna arrangement for mobile communication, the antenna arrangement comprising a plurality of radiators (202, 203) for at least two different frequency bands, the plurality of radiators being placed on a reflector (204), wherein the plurality of radiators comprises a first group of radiators arranged to operate in a first frequency band of the at least two different frequency bands, wherein the plurality of radiators comprises a second group of radiators arranged to operate in a second frequency band of the at least two different frequency bands, the first group of radiators forming a first antenna, the second group of radiators forming a second antenna, wherein the radiators are cross-polarized, wherein the radiators (203) of the first group are of cross-type, and wherein the radiators (202) of the second group are of four-leaf type.

### TECHNICAL FIELD

The present invention relates to an antenna arrangement for mobile communication, the antenna arrangement comprising a plurality of radiators for at least two different frequency bands, the plurality of radiators being placed on a reflector. Further, the present invention relates to a base station for mobile communication comprising at least one antenna arrangement of the above-mentioned sort.

### BACKGROUND OF THE INVENTION

A typical communications antenna arrangement may comprise a plurality of radiating antenna elements, an antenna feeding network and a reflector. The radiators are typically arranged in columns, each column of radiators forming one antenna. The radiators may by single or dual polarized; in the latter case, two feeding networks are needed per antenna, one for each polarization. Radiators are commonly placed as an array on the reflector, in most cases as a one-dimensional array extending in the vertical plane, but also two-dimensional arrays are used. For the sake of simplicity, only one-dimensional arrays are considered below, but this should not be considered as limiting the scope of this patent. The radiating performance of an antenna is limited by its aperture, the aperture being defined as the effective antenna area perpendicular to the received or transmitted signal. The antenna gain and lobe widths are directly related to the antenna aperture and the operating frequency. As an example, when the frequency is doubled, the wavelength is reduced to half, and for the same aperture, gain is doubled, and lobe width is halved. For the array to perform properly, the radiators are usually separated by a distance which is a slightly less than the wavelength at which they operate, hence the gain will be proportional to the number of radiators used, and the lobe width inversely proportional to the number of radiators.

With the proliferation of cellular systems (GSM, DCS, UMTS, LTE, Wi-MAX, etc.) and different frequency bands (700 MHz, 800 MHz, 900 MHz, 1800 MHz, 1900 MHz, 2600 MHz, etc.) it has become advantageous to re-group antennas for different cellular systems and different frequency bands into one multi-band antenna. A common solution is to have a Low Band Antenna (e.g. GSM 800or GSM 900) combined with one or more High Band Antennas (e.g. DCS 1800, PCS 1900 or UMTS 2100). Frequency bands being made available more recently, such as the 2600 MHz band can also be included in a multiband antenna arrangement. The Low Band Antenna is commonly used to achieve best cell coverage, and it is essential that the gain is as high as possible. The High Band Antennas are used to add another frequency band for increased capacity, and the gain has until recently not been optimised, the tendency has been to keep similar vertical lobe widths for both bands resulting in a smaller aperture for the High Band Antenna compared with the aperture of the Low Band Antenna, typically about half that of the Low Band Antenna. This has also allowed for e.g. two High Band Antennas 115 to be stacked one above the other beside a Low Band Antenna 116 in a side-by-side configuration (FIG. 1a). These two antennas can be used for two different frequency bands (e.g. PCS 1900 and UMTS 2100 or LTE 2600). Another configuration which is used is the interleaved antenna. In this configuration dual band radiating elements 113 which consist of a combined Low Band radiator and a High Band radiator as described in WO2006/058658-A1 are used, together with single band Low Band 111 and High Band radiators 112 (FIG. 1b).

### SUMMARY OF THE INVENTION

The inventors of the present invention have found drawbacks associated with prior art multi-band antenna arrangements as the High Band antenna does not use the full vertical aperture available on the reflector. With smartphones being more and more used, the focus for deployment of cellular networks has shifted from providing voice calls towards data traffic. Operators have an urgent need to provide more capacity for data traffic, often in combination with new cellular systems such as LTE.

Cellular standards such as CDMA and LTE are designed in such a way that higher received power will yield higher data traffic throughput. A way to obtain higher received power is to increase the gain of the base station antenna; this can be achieved by increasing the antenna aperture.

One problem with increasing the aperture of the High Band antenna has been that the loss of a conventional feeding network based on narrow flexible cables increases more with number of radiators at higher frequencies compared with lower frequencies, and therefore part or the entire extra gain achieved by increasing the antenna aperture is lost in the feeding network. Newer cellular standards such as LTE standard include the use of MIMO, Multiple Input Multiple Output antennas in order to increase data throughput by using several antennas which receive signals which have low correlation. Therefore, it can be advantageous to add more antennas in a multi band antenna arrangement. A problem with using dual band dipoles as described in WO2006/058658-A1 is that as the High Band Dipole influences the performance of the Low Band dipoles, it is difficult optimize the performance of both Low Band and High Band at the same time.

If separate radiators are used for Low Band and High Band in a multiband antenna, radiators for different frequency bands need to operate close to each other. They can then negatively influence each other's radiation patterns, or couple unwanted signals between themselves. The object of the present invention is to improve the performance of a multi band antenna arrangement.

The above-mentioned objects of the present invention are attained by providing an antenna arrangement for mobile communication, the antenna arrangement comprising a plurality of radiators for at least two different frequency bands, the plurality of radiators being placed on a reflector, wherein the plurality of radiators comprises a first group of radiators arranged to operate in a first frequency band of the at least two different frequency bands, wherein the plurality of radiators comprises a second group of radiators arranged to operate in a second frequency band of the at least two different frequency bands, the first group of radiators forming a first antenna, the second group of radiators forming a second antenna, wherein the radiators are cross-polarized, wherein the radiators of the first group are of cross-type, and wherein the radiators of the second group are of four-leaf type.

By means of the antenna arrangement of the present invention, the performance of a multi band antenna arrangement is improved.

The reflector may be made of conductive material, preferably a metal or metal composition, but other electrically conductive materials may also be used. Radiators may be placed in front of the reflector. The radiators are preferably dipoles, but other radiators such as patches can also be used. Radiators can have different polarizations such as horizontal, vertical or plus 45 degrees or minus 45 degrees, or any other polarizations. Two polarizations can be combined in the same radiating element to form a dual polarization dipole. The radiating elements for each row and for each polarization may be fed from one connector via feeding network. Especially for higher frequencies such as 1800 MHz or 2600 MHz, losses in the feeding network can be significant when the entire antenna aperture is used, and it is advantageous to use a low-loss feeding network e.g. as disclosed in WO WO2005/101566-A1, but considering that the Low Band is often used for coverage, a low loss feeding network is also beneficial for the Low Band. The purpose of the distribution network is to distribute the signal from the common connector to radiators. The phase and amplitude of the signals being fed from the radiators are defined in such a way as to obtain the desired radiation pattern in the vertical diagram. The pattern can have a tilt in the vertical plane, and can be optimised in terms of null-fill and upper side lobe suppression in way which is well-known to a person skilled in the art. In the same way, variable phase shifters can be used in the feeding network to provide adjustable vertical tilt.

When the entire aperture is used for a High Band antenna, the vertical beamwidth can become so small as to become impractical because of e.g. problems in correctly adjusting the vertical tilt of the antenna. It can then be advantageous to optimise the feeding network to further optimize the antenna side lobes to improve the coverage of the covered cell, and to reduce signals being transmitted in un-wanted directions, thus reducing interference in the cellular system. Such optimization of the side lobe pattern usually will increase the beam width at the expense of antenna gain, but will improve the cellular overall performance as interference is reduced.

With new cellular standards such as LTE including MIMO, it is advantageous to provide antenna arrangements which include several antennas for the same frequency band. With e.g. two antenna columns with dual-polarized radiators, 4 times MIMO can be achieved. MIMO requires that the signal received by each channel (corresponding to e.g. one polarization in one antenna) have low correlation. Low correlation can be achieved e.g. by using orthogonal polarizations, or separating the antennas, or a combination of both. For optimal de-correlation using antenna separation, several wavelengths separation is required; hence two antennas for the same frequency band side by side will not be optimal.

A better solution in a multi band antenna arrangement may be to place an antenna for another frequency band between the two antennas of the same frequency band used for MIMO.

A possible range of radiators which can be used in a multiband antenna arrangement are dipoles. Today, in cellular systems, dual polarized elements are almost exclusively used, commonly in a plus/minus 45 degrees configuration. Basic T-shaped dipoles have the advantage of providing excellent radiation efficiency, but have rather poor bandwidth. The dipole bandwidth can be improved by providing more advanced structure. One such structure for a dual polarized dipole is the four-leaf clover structure as shown in FIG. 5 which also has excellent bandwidth performance. This dipole will give excellent result in a multiband antenna arrangement when used for the High Band antenna, but if used for the Low Band antenna, its size will be very large. Also, the distance between the dipole and the reflector is typically in the order of a quarter wavelength, thus, large Low Band dipoles will partly mask the High Band dipoles giving a negative impact on the High

Band radiation pattern and causing unwanted coupling between the dipoles of different frequency bands. The inventors have found that for the Low Band antenna, it is therefore advantageous to use a cross-type dipole as shown in FIG. 6. It is stressed that the shape shown in FIG. 5 is not the only one which can be advantageously be used for the High Band dipole, other configurations are possible such a as providing a square frame as described in WO2005/060049-A1, or having dipoles formed by square plates as shown in WO2008/017386-A1, or using triangular plates. By providing large bandwidth radiators which cover e.g. the frequency band 1700 to 2200 MHz, several antennas within the antenna arrangement can have the same dipole but work with different cellular systems at different frequency bands e.g. PCS 1900 and UMTS 2100, or the different antennas can be used for MIMO for one cellular system, e.g. LTE.

According to an advantageous embodiment of the antenna arrangement according to the present invention, the radiators of the first group are Low Band radiators, and the radiators of the second group are High Band radiators.

According to a further advantageous embodiment of the antenna arrangement according to the present invention, the radiators of the first group are aligned in a first row, wherein the radiators of the second group are aligned in a second row parallel to the first row.

According to another advantageous embodiment of the antenna arrangement according to the present invention, the antenna arrangement comprises the reflector, e.g. an electrically conductive reflector, wherein the reflector has a longitudinal extension along a longitudinal axis, and wherein the first and second rows are parallel to the longitudinal axis.

According to yet another advantageous embodiment of the antenna arrangement according to the present invention, the plurality of radiators comprises a third group of radiators forming a third antenna, wherein the radiators of the third group are aligned in a third row parallel to the first and second rows.

According to an advantageous embodiment of the antenna arrangement according to the present invention, the radiators of the third group are arranged to operate in a third frequency band different from the first and second frequency bands.

According to a further advantageous embodiment of the antenna arrangement according to the present invention, the radiators of the third group are of four-leaf type. Advantageously, the radiators of the third group may be High Band radiators.

According to another advantageous embodiment of the antenna arrangement according to the present invention, the first group of radiators is located between the second and third groups.

According to another advantageous embodiment of the antenna arrangement according to the present invention, the radiators of the first group have the same antenna aperture, e.g. the same antenna aperture length, as the radiators of the second group. The radiators of the first group may have the same antenna aperture, e.g. the same antenna aperture length, in the direction of the longitudinal axis of the reflector, as the radiators of the second group.

According to an advantageous embodiment of the antenna arrangement according to the present invention, the third group or row of radiators has the same antenna aperture, e.g. the same antenna aperture length, as the first and second groups or rows of radiators.

According to a further advantageous embodiment of the antenna arrangement according to the present invention, the radiators of the first group have the same vertical aperture, as the radiators of the second group, when the reflector is mounted to extend in a vertical direction.

According to an advantageous embodiment of the antenna arrangement according to the present invention, the ratio between at least two of the frequency bands is in the order of two or higher.

According to another advantageous embodiment of the antenna arrangement according to the present invention, the antenna arrangement comprises the reflector, e.g. an electrically conductive reflector, wherein the reflector has a longitudinal extension along a longitudinal axis, and wherein each of the groups of radiators utilizes the entire antenna aperture made available by the reflector in the direction of the longitudinal axis.

According to yet another advantageous embodiment of the antenna arrangement according to the present invention, the antenna arrangement comprises an antenna feeding network connected to the radiators, wherein the antenna feeding network comprises a plurality of air-filled coaxial lines.

According to still another advantageous embodiment of the antenna arrangement according to the present invention, the antenna arrangement is a multiband antenna arrangement.

According an advantageous embodiment of the antenna arrangement according to the present invention, a first vertical column of radiators for one frequency band is arranged essentially along the entire height of the antenna reflector, and a second vertical column of radiators for a second frequency band is arranged essentially along the entire height of the same antenna.

According to another advantageous embodiment of the antenna arrangement according to the present invention, a first vertical column of radiators for one frequency band is arranged essentially along the entire height of the antenna reflector, and a second vertical column of radiators for a second frequency band is arranged essentially along the entire height of the same antenna reflector, and a third vertical column of radiators for a second frequency band is arranged essentially along the entire height of the same antenna reflector.

According to yet another advantageous embodiment of the antenna arrangement according to the present invention, a first vertical column of radiators for one frequency band is arranged essentially along the entire height of the antenna reflector, and a second vertical column of radiators for a second frequency band is arranged essentially along the entire height of the same antenna reflector, and a third vertical column of radiators for a third frequency band is arranged essentially along the entire height of the same antenna reflector.

According to yet another advantageous embodiment of the antenna arrangement according to the present a first vertical column of radiators for one frequency band is arranged along the height of the antenna reflector, the radiators being cross-shaped, and a second vertical column of radiators for a second frequency band is arranged along the height of the same antenna reflector, the radiators being four leaf clover shaped, and a third vertical column of radiators for a third frequency band is arranged along the height of the same antenna reflector, the radiators being four leaf clover shaped.

The above-mentioned objects of the present invention are also attained by providing a base station for mobile communication, wherein the base station comprises at least one antenna arrangement as claimed in any of the claims 1 to 16 and/or at least one antenna arrangement according to any of the other disclosed embodiments of the apparatus. Positive technical effects of the base station according to the present invention, and its embodiments, correspond to the technical effects mentioned in connection with the antenna arrangement according to the present invention, and its embodiments.

The above-mentioned features and embodiments of the antenna arrangement and the base station, respectively, may be combined in various possible ways providing further advantageous embodiments.

Further advantageous embodiments of the device according to the present invention and further advantages with the present invention emerge from the detailed description of embodiments.

### BRIEF DESCRIPTION OF THE DRAWINGS

The present invention will now be described, for exemplary purposes, in more detail by way of embodiments and with reference to the enclosed drawings, in which:

FIG. 1a is a schematic view of side by side multi band antenna of prior art which has one Low Band antenna and two superimposed High Band antennas;

FIG. 1b is a schematic view of an interleaved multi band antenna of prior art with one Low Band and one High Band antenna;

FIG. 2 is a schematic view of an embodiment the multi band antenna, with one Low Band and one High Band antenna;

FIG. 3 is a schematic view of an embodiment the multi band antenna, with one middle Low Band antenna and two High Band antennas on each side of the Low Band antenna;

FIG. 4 is a schematic side view of and embodiment of the multi band antenna, with one middle Low Band antenna and two High Band antennas on each side of the Low Band antenna;

FIG. 5 is an embodiment of a four-leaf clover type dipole; and

FIG. 6 is an embodiment of a cross type dipole.

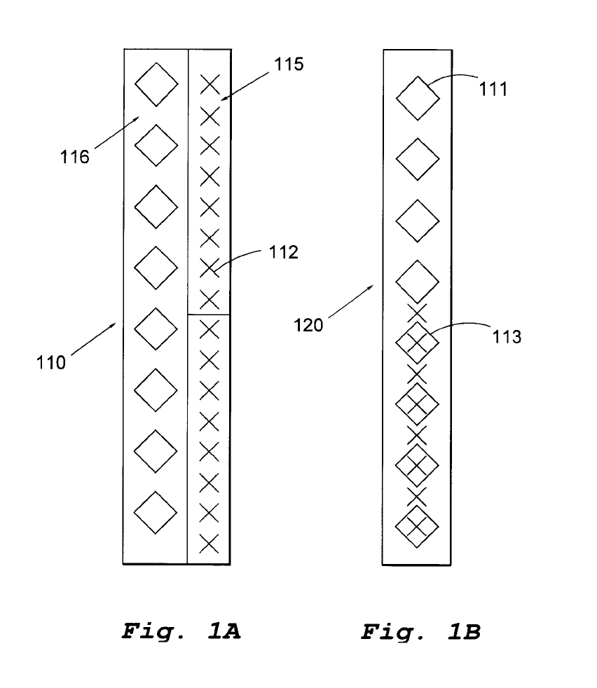

### DETAILED DESCRIPTION OF PREFERRED EMBODIMENTS

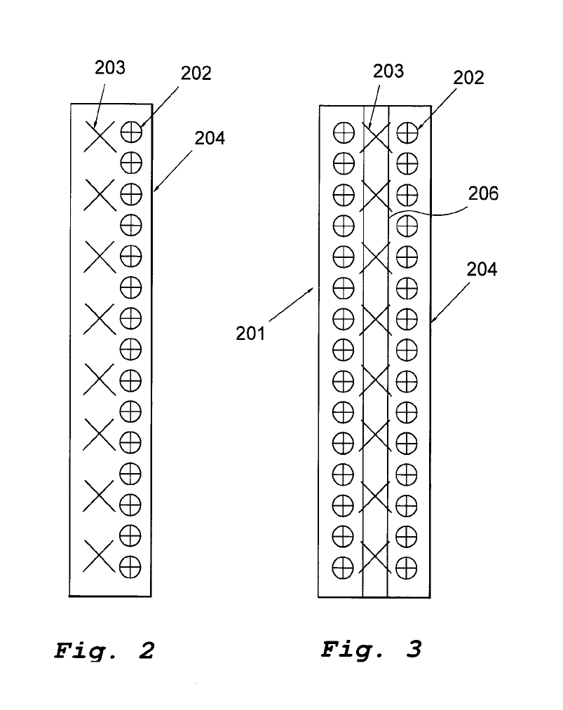

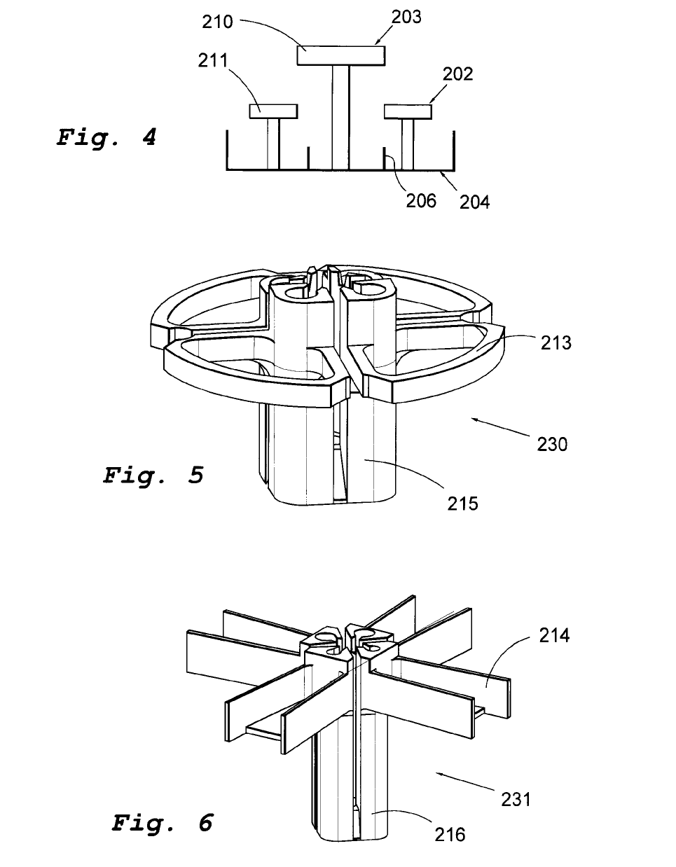

FIGS. 2-4 schematically show aspects of embodiments of the antenna arrangements according to present invention, comprising a reflector 204, and radiators 202 and 203. In FIG. 2, a first column of Low Band radiators 203 are placed on a reflector 204. A second column of High Band radiators 202 are placed next to the first column. The High Band radiators 202 are smaller than the Low Band radiators 203, and the separation between radiators is smaller than for the Low Band radiators, hence more High Band radiators are needed in order to occupy the full height of the reflector. In FIG. 3, a first column of Low Band radiators 203 is placed in the middle of the reflector 204. A second column of High Band radiators 202 is placed to one side of the first column, and a third column of High Band radiators 202 is placed on the other side of the other side of the first column. All three columns occupy the full height of the reflector 204. FIG. 4 shows a schematic side view of an embodiment of the antenna arrangement according to present invention. Low Band dipole 210 of Low Band radiator 203 is located approximately a quarter wavelength, in relation to the Low Band, from the reflector 204, and High band dipole 211 is located approximately a quarter wavelength, in relation to the High Band, from the reflector 204. It can be seen that the Low Band dipole 210 will extend above the High Band dipole 211, and it is therefore advantageous to use a Low Band dipole which extends as little as possible over the High Band dipole in order to reduce the impact of the Low Band dipole on the High Band radiation characteristics. A ridge 206 is placed between the High Band radiators and the Low Band radiators in order to reduce coupling between bands, and reduce the azimuth beamwidth of the Low Band and High Band lobes.

FIG. 5 shows an embodiment of a High Band four-leaf type dipole radiator 230, e.g. in the form of a High Band four-clover leaf type dipole radiator 230. It consists of four essentially identical dipole halves 213. Two opposing dipole halves 213 form one first dipole. The other two opposing dipole halves 213 form a second dipole which has a polarization which is orthogonal to the first dipole. The dipole support 215 positions the dipoles at approximately a quarter wavelength from the reflector, and is also used to form two baluns, one for each dipole. FIG. 6 shows an embodiment of a Low Band cross type dipole 231. It consists of four essentially identical dipole halves 214. Two opposing dipole halves 214 form one first dipole. The other two opposing dipole halves 214 form a second dipole which has a polarization which is orthogonal to the first dipole. The dipole support 216 positions the dipoles at approximately a quarter wavelength from the reflector, and is also used to form two baluns, one for each dipole.

Each radiator may be defined as a radiating element or radiating antenna element. Each radiator may comprise an electrically conductive antenna element.

The features of the different embodiments of the antenna arrangement disclosed above may be combined in various possible ways providing further advantageous embodiments.

The invention shall not be considered limited to the embodiments illustrated, but can be modified and altered in many ways by one skilled in the art, without departing from the scope of the appended claims.

1. An antenna arrangement for mobile communication, the antenna arrangement comprising a plurality of radiators for at least two different frequency bands, the plurality of radiators being placed on a reflector, wherein the plurality of radiators comprises a first group of radiators arranged to operate in a first frequency band of the at least two different frequency bands, wherein the plurality of radiators comprises a second group of radiators arranged to operate in a second frequency band of the at least two different frequency bands, the first group of radiators forming a first antenna, the second group of radiators forming a second antenna, wherein the radiators are cross-polarized, wherein the radiators of the first group are of cross-type, and wherein the radiators of the second group are of four-leaf type.

2. The antenna arrangement according to claim 1, wherein the radiators of the first group are Low Band radiators, and in that the radiators of the second group are High Band radiators.

3. The antenna arrangement according to claim 1, wherein the radiators of the first group are aligned in a first row, and the radiators of the second group are aligned in a second row parallel to the first row.

4. The antenna arrangement according to claim 3, wherein the antenna arrangement comprises the reflector, e.g. an electrically conductive reflector, the reflector has a longitudinal extension along a longitudinal axis, and the first and second rows are parallel to the longitudinal axis.

5. The antenna arrangement according to claim 3, wherein the plurality of radiators comprises a third group of radiators forming a third antenna, the radiators of the third group are aligned in a third row parallel to the first and second rows.

6. The antenna arrangement according to claim 5, wherein the radiators of the third group are arranged to operate in a third frequency band different from the first and second frequency bands.

7. The antenna arrangement according to claim 5, wherein the radiators of the third group are of four-leaf type.

8. The antenna arrangement according to claim 7, wherein the radiators of the third group are High Band radiators.

9. The antenna arrangement according to claim 5, wherein the first group of radiators is located between the second and third groups.

10. The antenna arrangement according to claim 1, wherein the radiators of the first group have the same antenna aperture, e.g. the same antenna aperture length, as the radiators of the second group.

11. The antenna arrangement according to claim 10, wherein the radiators of the first group have the same vertical aperture, as the radiators of the second group, when the reflector is mounted to extend in a vertical direction.

12. The antenna arrangement according to claim 10, wherein the third group or row of radiators has the same antenna aperture, e.g. the same antenna aperture length, as the first and second groups or rows of radiators.

13. The antenna arrangement according to claim 1, wherein the ratio between at least two of the frequency bands is in the order of two or higher.

14. The antenna arrangement according to claim 1, wherein the antenna arrangement comprises the reflector, e.g. an electrically conductive reflector, the reflector has a longitudinal extension along a longitudinal axis, and each of the groups of radiators utilizes the entire antenna aperture made available by the reflector in the direction of the longitudinal axis.

15. The antenna arrangement according to claim 1, wherein the antenna arrangement comprises an antenna feeding network connected to the radiators, and the antenna feeding network comprises a plurality of air-filled coaxial lines.

16. The antenna arrangement according to claim 1, wherein the antenna arrangement is a multiband antenna arrangement.

17. A base station for mobile communication, wherein the base station comprises at least one antenna arrangement a plurality of radiators for at least two different frequency bands, the plurality of radiators being placed on a reflector, wherein the plurality of radiators comprises a first group of radiators arranged to operate in a first frequency band of the at least two different frequency bands, wherein the plurality of radiators comprises a second group of radiators arranged to operate in a second frequency band of the at least two different frequency bands, the first group of radiators forming a first antenna the second group of radiators forming a second antenna wherein the radiators are cross-polarized, wherein the radiators of the first group are of cross-type, and wherein the radiators of the second group are of four-leaf type.

18. The base station for mobile communication of claim 17 wherein the radiators of the first group are Low Band radiators, and the radiators of the second group are High Band radiators.

19. The base station for mobile communication of claim 17 wherein the radiators of the first group are aligned in a first row, and the radiators of the second group are aligned in a second row parallel to the first row.

20. The base station for mobile communication of claim 19 wherein the antenna arrangement comprises the reflector, e.g. an electrically conductive reflector, the reflector has a longitudinal extension along a longitudinal axis, and the first and second rows are parallel to the longitudinal axis.

21. The base station for mobile communication of claim 19 wherein the plurality of radiators comprises a third group of radiators forming a third antenna, the radiators of the third group are aligned in a third row parallel to the first and second rows.

22. The base station for mobile communication of claim 21 wherein the radiators of the third group are arranged to operate in a third frequency band different from the first and second frequency bands.

23. The base station for mobile communication of claim 21 wherein the radiators of the third group are of four-leaf type.

24. The base station for mobile communication of claim 23 wherein the radiators of the third group are High Band radiators.

25. The base station for mobile communication of claim 21 wherein the first group of radiators is located between the second and third groups.

26. The base station for mobile communication of claim 17 wherein the radiators of the first group have the same antenna aperture, e.g. the same antenna aperture length, as the radiators of the second group.

27. The base station for mobile communication of claim 26 wherein the radiators of the first group have the same vertical aperture, as the radiators of the second group, when the reflector is mounted to extend in a vertical direction.

28. The base station for mobile communication of claim 26 wherein the third group or row of radiators has the same antenna aperture, e.g. the same antenna aperture length, as the first and second groups or rows of radiators.

29. The base station for mobile communication of claim 17 wherein the ratio between at least two of the frequency bands is in the order of two or higher.

30. The base station for mobile communication of claim 17 wherein the antenna arrangement comprises the reflector, e.g. an electrically conductive reflector, the reflector has a longitudinal extension along a longitudinal axis, and each of the groups of radiators utilizes the entire antenna aperture made available by the reflector in the direction of the longitudinal axis.

31. The base station for mobile communication of claim 17 wherein the antenna arrangement comprises an antenna feeding network connected to the radiators, and the antenna feeding network comprises a plurality of air-filled coaxial lines.

32. The base station for mobile communication of claim 17 wherein the antenna arrangement is a multiband antenna arrangement.
